(19) United States
(12) Patent Application Publication
(10) Pub. No.: US 2005/0003758 A1
(43) Pub. Date: Jan. 6, 2005

(54) Vehicle-used blue-tooth hand free structure for handset

(76) Inventor: Li Kai Man, Shin Jie (TW)

Correspondence Address: Li Kai Man, 235 Chung-Ho, P.O. Box 10-69, Taipei, TW

(21) Appl. No.: 10/800,799

(22) Filed: Mar. 16, 2004

(30) Foreign Application Priority Data
May 30, 2003 (TW) 092210054

(51) Int. Cl. H01R 13/44

(52) U.S. Cl. 455/41.2

(57) ABSTRACT

A vehicle-used blue-tooth hand free structure has a machine body. The machine body comprises an upper cover; a circuit board located blow the upper cover; and a lower cover below the circuit board. The circuit board is installed with a power seat, an earphone receptacle; a receiving and transmitting switch; a closing switch, a power switch, a light emitting diode unit, a volume control button and a blue tooth device. A lower cover is installed below the circuit board. A rear end of the lower cover is installed with a charging battery. A microphone is installed at a front end of the lower cover. The microphone is electrically connected to the circuit board. Thereby, the charging battery is electrically connected to the circuit board. When the power seat of the circuit board is connected to an external power source, the charging battery will charge an object.

### FIELD OF THE INVENTION

The present invention relates to blue tooth devices, and particular to a vehicle-used blue-tooth hand free structure for a handset. By the present invention, the users absorb less radiation. The microphone is convenient for users. The joint of the charging battery can be connected to various power plugs. The microphone serves a hand free operation.

### BACKGROUND OF THE INVENTION

With reference to FIG. 8, a prior art hanging structure A for a mobile hone is illustrated. The hanging structure must be connected to a power charge wire. It is often that the mobile phone does not work due to lack of power so that the users cannot communicate with others. As a result, it is often that some businesses are lost. Thereby, the charging power wire is wound improperly. However, it is possible that some accidents occur as the users are driving. In driving, it is often that the driver holds a mobile phone by one hand and drives. This is very dangerous and is illegal. However, to hold a handset will cause a larger radiation to affect the body of the user. In driving, it is inconvenient to take a phone for receiving a call. Thereby, no microphone is installed in the prior art. Moreover, a single one plug cannot be used in various application so that often the plug can not work due to mismatch of the plug and a receptacle.

### SUMMARY OF THE INVENTION

Accordingly, the primary object of the present invention is to provide a vehicle-used blue-tooth hand free structure having a machine body. The machine body comprises an upper cover; a circuit board located blow the upper cover; and a lower cover below the circuit board. The circuit board is installed with a power seat, an earphone receptacle; a receiving and transmitting switch; a closing switch, a power switch, a light emitting diode unit, a volume control button and a blue tooth device. A lower cover is installed below the circuit board. A rear end of the lower cover is installed with a charging battery. A microphone is installed at a front end of the lower cover. The microphone is electrically connected to the circuit board. Thereby, the charging battery is electrically connected to the circuit board. When the power seat of the circuit board is connected to an external power source, the charging battery will charge an object.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is a partial assembly view of the present invention.

FIG. 3 is a lateral view of the present invention.

FIG. 4 is a front perspective view of the present invention.

FIG. 5 is a perspective view of the present invention.

FIG. 6 is a schematic view showing the connection of the joint in the present invention.

FIG. 7 is a schematic view showing that the installation of the present invention in a vehicle.

FIG. 8 is a perspective view showing the installation of the prior art handset.

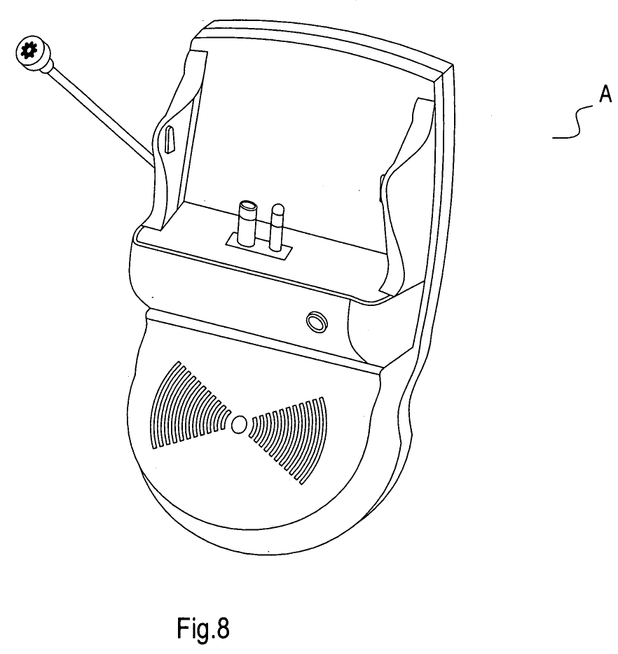

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

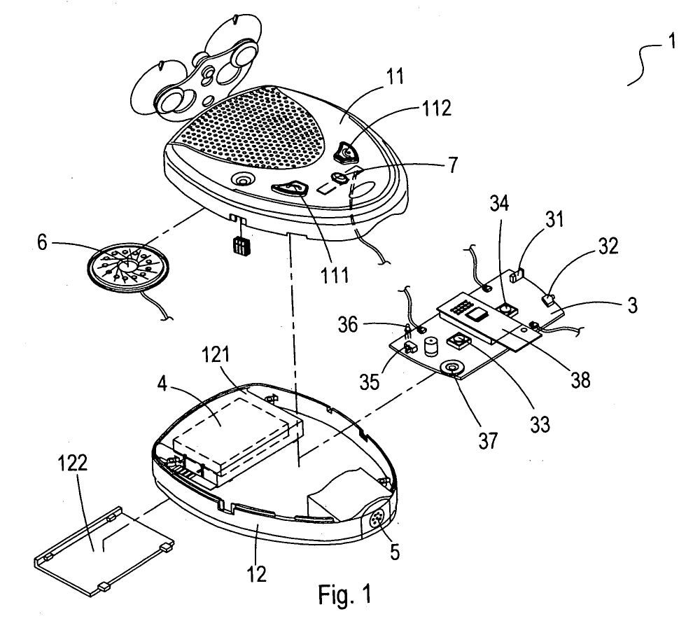

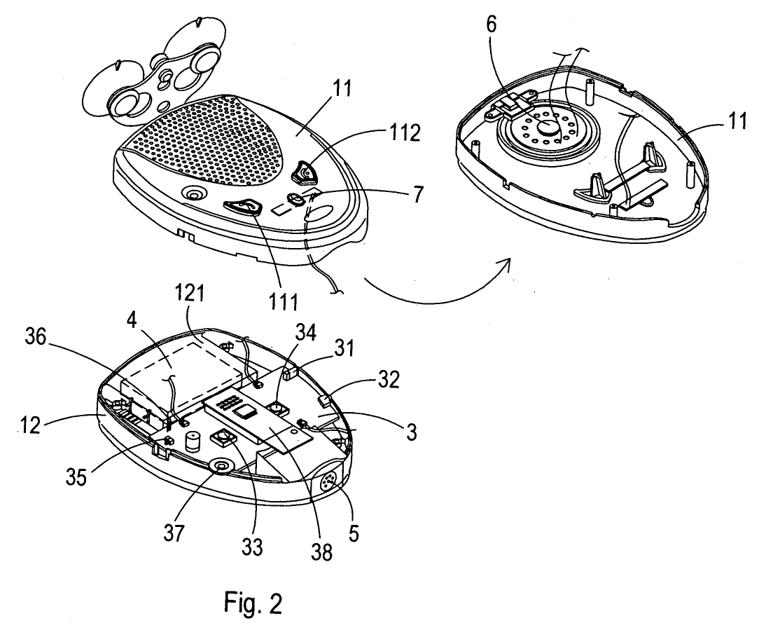

With reference to FIGS. 1 and 2, the vehicle-used blue-tooth hand free structure for a handset is illustrated. The vehicle-used blue-tooth hand free structure comprises the following elements. A machine body 1 includes an upper cover 11 and a lower cover 12; and a circuit board 3 installed between the upper cover 11 and the lower cover 12.

A blue tooth button 111 is installed at a top of the upper cover 11 for setting a code corresponding to that of a handset so as to have the same frequency to communicate with the handset as the blue tooth button is pressed.

A receiving button 112 is installed at the top of the upper cover 11 for receiving speech signals as the receiving button is pushed. A trumpet 6 is installed at a lower side of the upper cover 11. The trumpet 6 is electrically connected to the circuit board 3 for generating audio signals. A call incoming display 7 is installed connected the blue tooth button 111 and the receiving button 112 for displaying as signals are received.

The circuit board 3 is located blow the upper cover 11 and is installed with a power seat 31, an earphone receptacle 32; a receiving and transmitting switch 33; a closing switch 34, a power switch 35, a light emitting diode unit 36, a volume control button 37 and a blue tooth device 38.

The lower cover 12 is installed below the circuit board 3. A rear end of the lower cover 12 is installed with a charging battery 4 and a receiving groove 121 is formed in the lower cover 12. A lower side of the receiving groove 121 is installed with a battery cover 122. A microphone 5 is installed at a front end of the lower cover 12. The microphone 5 is electrically connected to the circuit board 3. Thereby, the charging battery 4 is electrically connected to the circuit board 3. When the power seat 31 of the circuit board 3 is connected to an external power source, the charging battery 4 can charge an object.

When the upper cover 11 and lower cover 12 are engaged, the blue tooth button 111 is arranged corresponding to the receiving and transmitting switch 33 and the receiving button 112 is arranged corresponding to the closing switch 34.

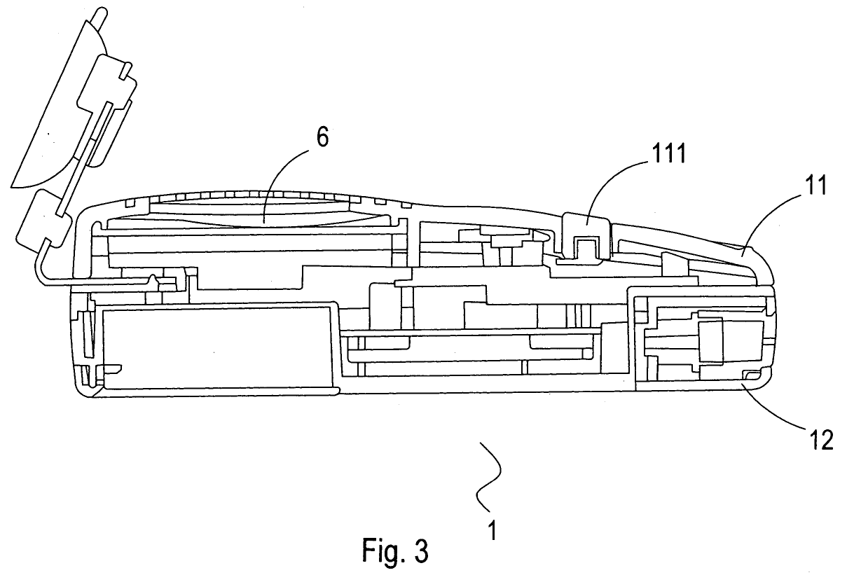

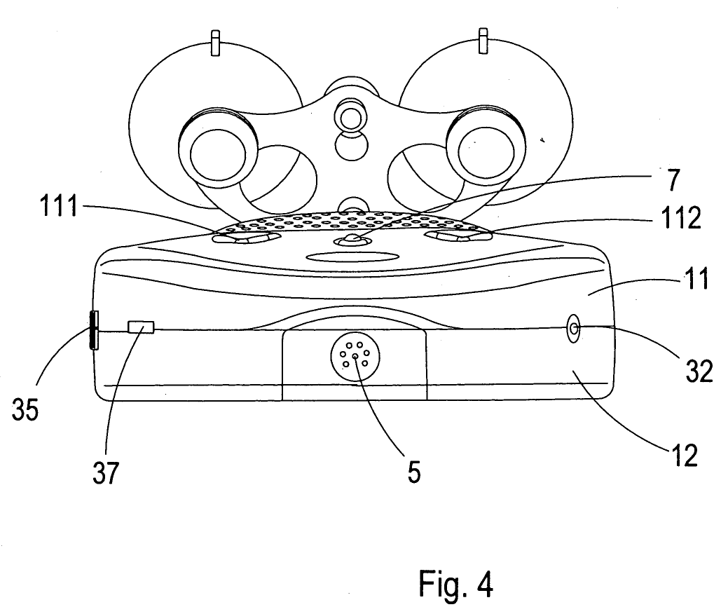

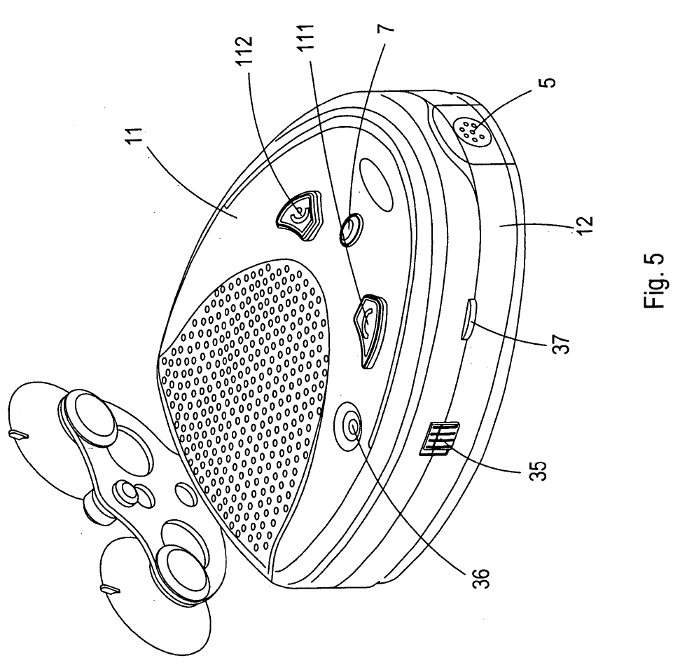

With reference to FIGS. 3, 4 and 5, in the vehicle-used blue-tooth hand free structure for a handset of the present invention, the machine body 1 is installed within a vehicle. The charging battery 4 is installed within the machine body 1. The machine body 1 provides signals from the blue tooth device 38 to the trumpet 6 for emission. Thereby, in driving, the user can communicate through the earphone receptacle 32 so as to be operated conveniently and the received radiation is greatly reduced.

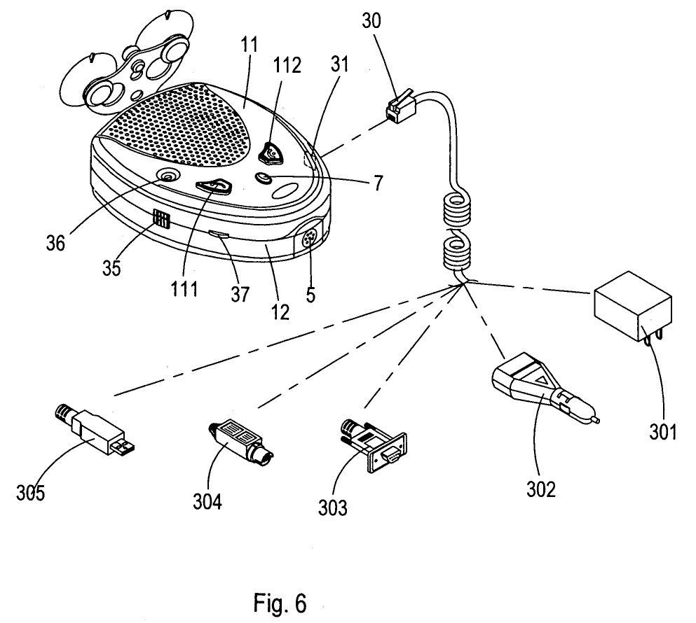

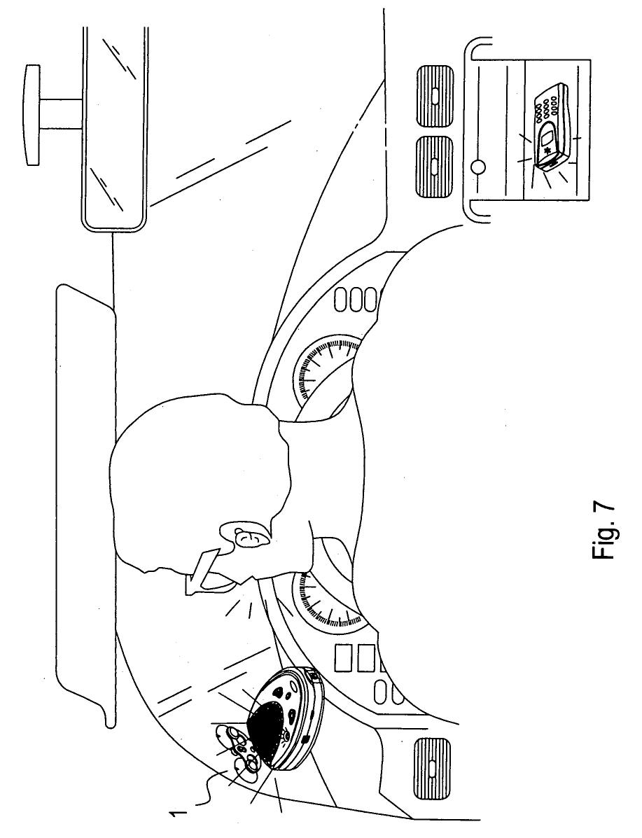

With reference to FIGS. 6 and 7, the power seat 31 is installed at a right side of the machine body 1. The power seat 31 provides a joint 30. One end of the joint 30 is connected to the charging battery 4 so as to charge an object. Another end of the joint 30 is connected to one of the plugs 301, 302, 303, 304, and 305 for charging different objects.

Advantages of the present invention is that the present invention can be placed independently indoors, tables, or vehicles. Moreover, the users absorb less radiation. The microphone is convenient for users. The joints of the charging battery can be connected to various power plugs. The microphone provides a hand free operation.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A vehicle-used blue-tooth hand free structure having a machine body; the machine body comprising:
an upper cover;
a circuit board located blow the upper cover and installed with a power seat, an earphone receptacle; a receiving and transmitting switch; a closing switch, a power switch, a light emitting diode unit, a volume control button and a blue tooth device;
a lower cover installed below the circuit board; a rear end of the lower cover being installed with a charging battery and a receiving groove being formed in the lower cover; a lower side of the receiving groove being installed with a battery cover; a microphone being installed at a front end of the lower cover; the microphone being electrically connected to the circuit board; thereby, the charging battery being electrically connected to the circuit board; when the power seat of the circuit board being connected to an external power source, the charging battery will charge an object.

2. The vehicle-used blue-tooth hand free structure for a handset as claimed in claim 1, wherein the upper cover further comprises:
a blue tooth button installed at a top of the upper cover for setting a code corresponding to that of a handset so as to have the same frequency to communicate with the handset as the blue tooth button is pressed; and
a receiving button installed at the top of the upper cover for receiving speech signals as the receiving button is pushed; a trumpet being installed at a lower side of the upper cover; the trumpet being electrically connected to the circuit board for generating audio signals; a call incoming display being installed connected the blue tooth button and the receiving button for displaying as signals are received;
wherein when the upper cover and lower cover are engaged, the blue tooth button is arranged corresponding to the receiving and transmitting switch and the receiving button is arranged corresponding to the closing switch.

3. The vehicle-used blue-tooth hand free structure for a handset as claimed in claim 1, wherein the power seat is installed at a right side of the machine body; the power seat provides a joint; one end of the joint is connected to the charging battery so as to charge an object; another end of the joint is connected to one of a various plugs for charging different objects.
